(19) United States
(12) Patent Application Publication
(10) Pub. No.: US 2007/0261095 A1
(43) Pub. Date: Nov. 8, 2007

(54) On the go video content distribution system

(76) Inventors: Gregory C. Petrisor, Los Angeles, CA (US); Ryan A. Perdue, Venice, CA (US)

Correspondence Address: Scot A. Reader, Esq.;Suite 228, 1320 Pearl Street, Boulder, CO, 80302, US

(21) Appl. No.: 11/800,308

(22) Filed: May 4, 2007

Related U.S. Application Data
(60) Provisional application No. 60/798,095, filed on May 5, 2006.

(51) Int. Cl. H04N 7/173; H04N 7/16; G06F 13/00; H04N 5/445

(52) U.S. Cl. 725/131; 725/62; 725/139; 725/51

(57) ABSTRACT

An improved video distribution system for the “on the go” consumer, such as the business traveler or hurried leisure traveler. In one aspect, the invention provides a video distribution system comprising a video distribution facility within a travel departure zone having video content files stored therein and one or more access units within one or more travel departure terminals of the travel departure zone, wherein each access unit is communicatively coupled with the video distribution facility via a respective wired connection and has one or more respective wired ports each adopted for short-term communicative coupling with a mobile electronic device to which one or more requested video content files stored in the video distribution facility is downloaded via the wired port for playback on the device at least in part after the device has been communicatively decoupled from the wired port.

### CROSS REFERENCE TO RELATED APPLICATION(S)

This application claims the benefit of U.S. provisional application No. 60/798,095 entitled “On-the-go Media Distribution System and Recorder/Player Adapted for Use Therein,” filed on May 5, 2006.

### BACKGROUND OF THE INVENTION

The present invention relates to an electronic media distribution system and, more particularly, to a video content distribution system adapted to allow a traveler to rapidly download large video files to a mobile electronic device for later viewing while in transit or at a travel destination.

It is known to distribute video content, such as movies, prerecorded television shows, video games and software applications, for later viewing on a mobile electronic device. The most popular storage medium at present for such video content is the digital video disc (DVD).

There are several known systems for distribution of video content for later viewing on a mobile electronic device. One such system is the “bricks and mortar” retail outlet where a DVD is acquired in-person. Another is mail order whereby a DVD is ordered by telephone or online and shipped to the consumer by mail. Still another is Internet download whereby video content is ordered online and a file containing the video content is downloaded over the Internet to the mobile electronic device. In the latter system, a single movie download can take hours with variable video quality.

None of these video distribution systems is well-suited for the “on the go” consumer, such as the business traveler or hurried leisure traveler. A rushed traveler often does not contemplate video entertainment until arrival at a travel departure terminal at which point options for acquiring video content for later viewing while in transit or at a travel destination are extremely limited.

Generally speaking, there are three points in the travel process at which the traveler has the opportunity to acquire video content. The first is the departure terminal. The second is the transit vessel (for example, in-flight entertainment, in-train entertainment, on-ship entertainment, etc.). The third is the place of accommodation at the travel destination (for example, hotel room, motel room, etc.). Each of these venues has constraints that limit the appeal of video entertainment offerings.

The departure terminal is a preferred location for video content acquisition as the video content can be viewed for the life of the trip (for example, in the terminal, in the airplane and in the hotel room). A conventional video distribution system in the departure terminal is the “bricks and mortar” video rental store. In-terminal video rental stores typically suffer from space constraints, which significantly limit the titles offered; high prices, due to high lease costs for terminal floor space; and logistical issues of returning the video content. Moreover, the rushed traveler often does not have ample time to walk through an in-terminal video rental store and find desired video content, much less to wait in line to purchase video content once found. Download via the Internet to the traveler's mobile electronic device of a file containing the video content is a possible alternative; however, the time required and poor quality of the download make this option impractical or unappealing for many travelers.

The transit vessel is a less attractive location for video content acquisition. A video distribution system in a transit vessel is typically limited to a built-in, in-transit entertainment system that streams the video content. Size, weight, power and cost constraints for in-transit entertainment systems, most notably in-flight entertainment systems, normally prevent the operator of the vessel from offering a large video library and limit the size of the personal viewing display. Moreover, in-transit entertainment systems often freeze due to motion of the vessel, have long reboot sequences and do not offer full function capability (for example, start, stop, pause, rewind, fast forward, etc.). In-transit entertainment systems are also regularly interrupted by announcements from the vessel operator. Finally, since the video content is streamed rather than downloaded as a complete file, the traveler is unable to remove the video content from the vessel when the trip is over. This can be frustrating if the traveler is in the middle of a movie or show when the vessel arrives at its destination.

The place of accommodation at the travel destination is an even less attractive location for video content acquisition. A significant drawback of the place of accommodation as a place for video content acquisition is that the in-transit portion of the trip, which is the point at which video entertainment is usually most desirable, is over. Moreover, built-in, in-room entertainment systems generally stream content, titles are typically limited and such systems often do not often provide full function capability.

Video content distribution systems specially adapted for travel departure terminals have been proposed. For example, Takanhashi U.S. Patent Application Publication No. 2003/0217366 describes a wireless video distribution system for a railroad or subway station. The proposed system would, however, have several drawbacks if ever implemented. First, bandwidth limitations inherent in wireless transmission would render video content download times too lengthy for many travelers. Bandwidth problems would be particularly acute for bandwidth-intensive downloads such as high definition movies, and would be further exacerbated by requisite sharing of wireless base station bandwidth under the access patterns prevalent in travel departure terminals. More particularly, access patterns in travel departure terminals are normally characterized by periods of access by large numbers of travelers just before departure of a vessel followed by periods of access by few or no travelers when no departure of a vessel is imminent. Already too lengthy wireless download times would thus be even longer when departure of a vessel is imminent and download speed is most critical. Moreover, the proposed architecture would deploy several intermediate switching nodes between the wireless base stations and the video content center arranged in a non-symmetric topology. A network manager would not only have to maintain these intermediate switching nodes but also find space in the train terminal with a power source and potentially a cooling mechanism for these nodes.

Additionally, the proposed system is subscription based and requires users to enter a service contract with the content provider before using the system. A rushed traveler generally would not have time to review a service contract. Moreover, the requirement to enter a service contract would provide a significant disincentive for the occasional traveler to use the system. Moreover, little or no consideration is given in the proposed system to how a traveler might find desired video content for download.

### SUMMARY OF THE INVENTION

The present invention, in a basic feature, provides an improved video distribution system for the “on the go” consumer, such as the business traveler or hurried leisure traveler.

The present invention, in one aspect, provides a video distribution system comprising a video distribution facility within a travel departure zone having video content files stored therein and one or more access units within one or more travel departure terminals of the travel departure zone, wherein each access unit is communicatively coupled with the video distribution facility via a respective wired connection and has one or more respective wired ports each adapted for short-term communicative coupling with a mobile electronic device to which one or more requested video content files stored in the video distribution facility is downloaded via the wired port for playback on the device at least in part after the device has been communicatively decoupled from the wired port.

In some embodiments, the video distribution system further comprises a video management facility outside the travel departure zone and communicatively coupled with the video distribution facility via the public Internet, wherein video content files are uploaded via the public Internet to the video distribution facility.

In some embodiments, the one or more travel departure terminals comprise a plurality of travel departure terminals.

In some embodiments, the travel departure zone comprises an airport and the one or more travel departure terminals are airport terminals.

In some embodiments, the wired port comprises one of an Ethernet port and a Universal Serial Bus (USB) port.

In some embodiments, the mobile electronic device comprises one of a portable computer and a network-capable handheld device having a video display.

In some embodiments, the one or more requested video content files comprise one of more of a standard definition feature film, a high definition feature film, a prerecorded television show, a video game and a software application.

In some embodiments, the one or more downloaded video content files include one or more digital rights management (DRM) restrictions.

The present invention, in another aspect, provides a travel departure zone comprising a video storage unit, a video server array communicatively coupled with the video storage unit, a load balancer communicatively coupled with the video server array and one or more access units each communicatively coupled with the load balancer via a respective wired connection and each having one or more respective wired ports each adapted for communicative coupling with a mobile electronic device to which the load balancer assigns a video server within the video server array for conducting a session with the device in which one or more video content files is downloaded from the video storage unit to the device via the wired port for playback on the device at least in part after the device has been communicatively decoupled from the wired port.

The present invention, in another aspect, provides a method for distributing video content in a travel departure zone comprising the steps of uploading a video content file to a video distribution facility within the travel departure zone, then, communicatively coupling a mobile electronic device to a wired port within a travel departure terminal of the travel departure zone, requesting the uploaded video content file via the wired port, downloading the requested video content file via the wired port, communicatively decoupling the device from the wired port, and then, commencing playback on the device of the downloaded video content file.

These and other aspects of the invention will be better understood by reference to the following detailed description taken in conjunction with the drawings that are briefly described below. Of course, the invention is defined by the appended claims.

### BRIEF DESCRIPTION OF THE DRAWINGS

FIG. 1 shows a video distribution system in some embodiments of the invention.

FIG. 2 shows a video distribution facility and a video management facility for a video distribution system in some embodiments of the invention.

FIG. 3 shows a home page for a video distribution system in some embodiments of the invention.

FIG. 4 shows a method for distributing video content without content preselection in some embodiments of the invention.

FIG. 5 shows a method for distributing video content with content preselection in some embodiments of the invention.

FIG. 6 shows a method for distributing video content with content preselection in other embodiments of the invention.

### DETAILED DESCRIPTION OF A PREFERRED EMBODIMENT

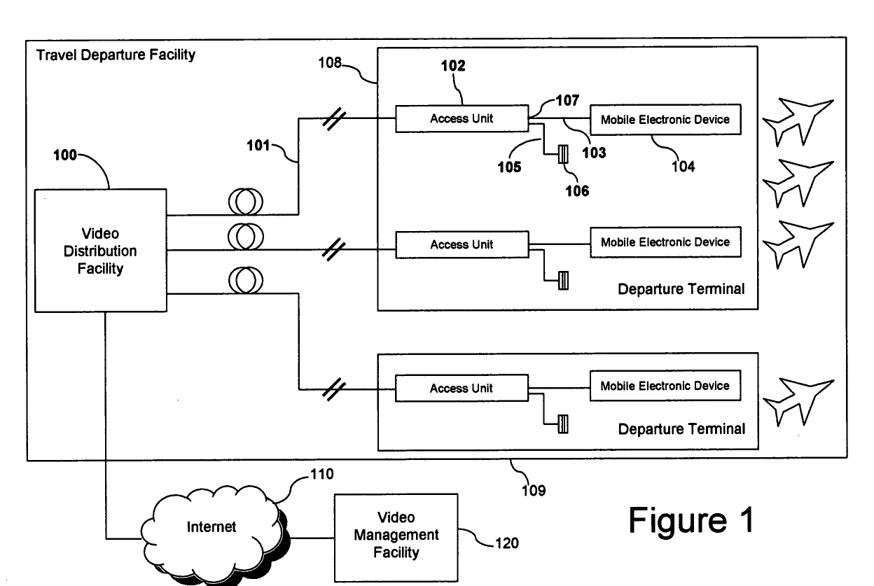

FIG. 1 shows a video distribution system in some embodiments of the invention. Generally speaking, the video distribution system is designed to support efficient searches for video content and high-speed download of video files to mobile electronic devices carried by “on the go” travelers, such as airline passengers waiting for departing flights. In some embodiments, downloaded video content includes standard and high definition movies and prerecorded television shows carried in Windows Media Video (WMV) files or Moving Picture Experts Group (MPEG) files. In some embodiments, downloaded video content additionally or alternatively includes video games or other application software.

The system includes an access unit 102 installed in a travel departure terminal 108. Access unit 102 is communicatively coupled via a high speed fiber optic link 101 to a video distribution facility 100 within a travel departure zone. In the illustrated embodiments, access unit 102, fiber optic link 101 and video distribution facility 100 are all resident within a travel departure facility 109. In other embodiments, the video distribution facility may reside in a building adjacent to the travel departure facility. In some embodiments, travel departure facility 109 is an airport and travel departure terminal 108 is an airline terminal operated by one or more airlines. As shown in FIG. 1, travel departure facility 109 may include multiple travel departure terminals each of which may be operated by a different group of one or more airlines and each of which has one or more access nodes, wherein each access node is communicatively coupled via a dedicated high speed fiber optic link to video distribution facility 100.

Access unit 102 has one or more wired ports 107 each adapted for short-term communicative coupling with a mobile electronic device 104 via a copper data link 103. Wired ports 107 may include Ethernet ports and USB ports, for example. Ethernet ports may support one or more variants of the wired Ethernet protocol defined in IEEE Std. 802.3, such as 1 Gigabit, 10 Gigabit and 40 Gigabit. Where all wired ports 107 are Ethernet ports, access unit 102 may consist in a standalone Ethernet access device having one or more exposed Ethernet ports and an uplink port that communicatively couples with fiber optic link 101. Where wired ports 107 include USB ports in addition to or in lieu of Ethernet ports, access unit 102 may consist in such an Ethernet access device in combination with a personal computer, wherein the personal computer has one or more exposed USB ports and an Ethernet uplink port that communicatively couples with one of the Ethernet ports on the Ethernet access device.

Access unit 102 is also connected to one or more payment card scanners 106 via one or more respective scanner data links 105 for receiving payment card information from a user of mobile electronic device 104. In some embodiments, each one of wired ports 107 has a dedicated one of payment card scanners 106. Payment card information may be transmitted to video distribution facility 100 via high speed fiber optic link 101 or via a separate data link. In either event, the Ethernet access device of access unit 102 may have a protocol converter to facilitate communication between video distribution facility 100, mobile electronic device 104 and payment card scanners 106.

Video distribution facility 100 has front-end connections to high speed fiber optic links, such as link 101, and a back-end connection to a video management facility 120 via the public Internet 110. Video management facility 120 is outside of the travel departure zone.

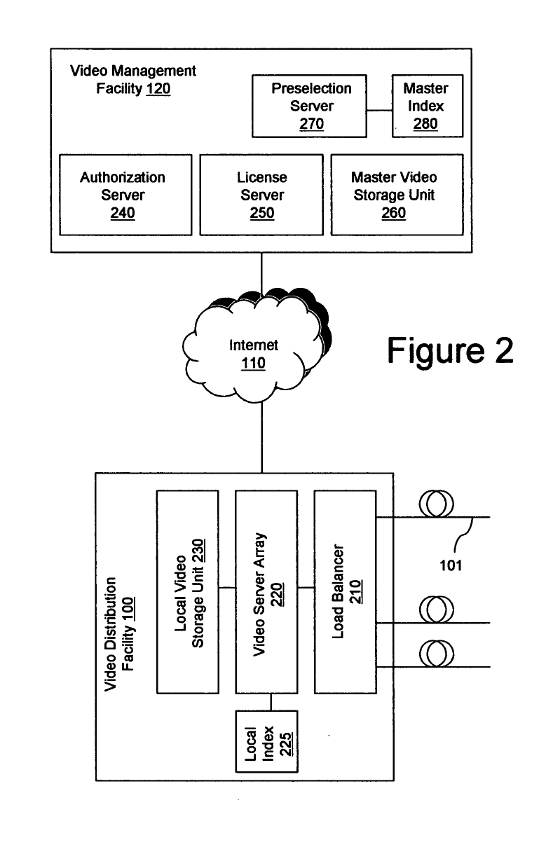

FIG. 2 shows video distribution facility 100 and video management facility 120 in more detail. Video distribution facility 100 includes a local video storage unit 230 that stores video content that is downloodable by mobile electronic devices, such as device 104, via wired ports 107. In some embodiments, Video storage unit 230 is a storage area network (SAN)-attached disk array. In other embodiments, a video storage unit is a network-attached storage (NAS) system. Video distribution facility 100 also includes a video server array 220. Video server array 220 includes a plurality of video servers adapted to process search and download requests received from mobile electronic devices, such as device 104, via high speed fiber optic links, such as link 101. Servers within array 220 interface with local content index 225 when processing search requests and interface with local video storage unit 230 when processing download requests. Servers within array 220 interface with authentication server 240 and license server 250 when processing requests. Servers within array 220 also interface with master video storage unit 260 to update the video content within local video storage unit 230. Such updates are generally independent of download requests and in some embodiments are performed only when the system is offline. Video distribution facility 100 also includes a load balancer 210. Load balancer 210 is a multi-port device that assigns inbound search and download requests to servers within array 220 based on an operative load sharing policy. Load balancer 210 maintains session persistence to ensure that once a request has been assigned to a video server all further requests within the session are sent to that server. While in the illustrated embodiments load balancer 210 is shown to be communicatively coupled with local video storage unit 230 via video server array 220, in some embodiments load balancer 210 has direct connectivity to local video storage unit 230.

Video management facility 120 includes an authorization server 240 that processes authorization requests received from servers within array 220 and associates authorization requests with preselected video content, a license server 250 that processes content key requests received from servers within array 220 and a master video storage unit 260 that stores a master copy of the video content stored on local video storage unit 230. Video management facility 120 may provide management services similar to those described herein with respect to video distribution facility 100 for other video distribution facilities resident in other travel departure zones.

Video management facility 120 also includes a preselection server 270 and a master content index 280 that may be invoked by users of the system to preselect and prepay for video content over an Internet connection.

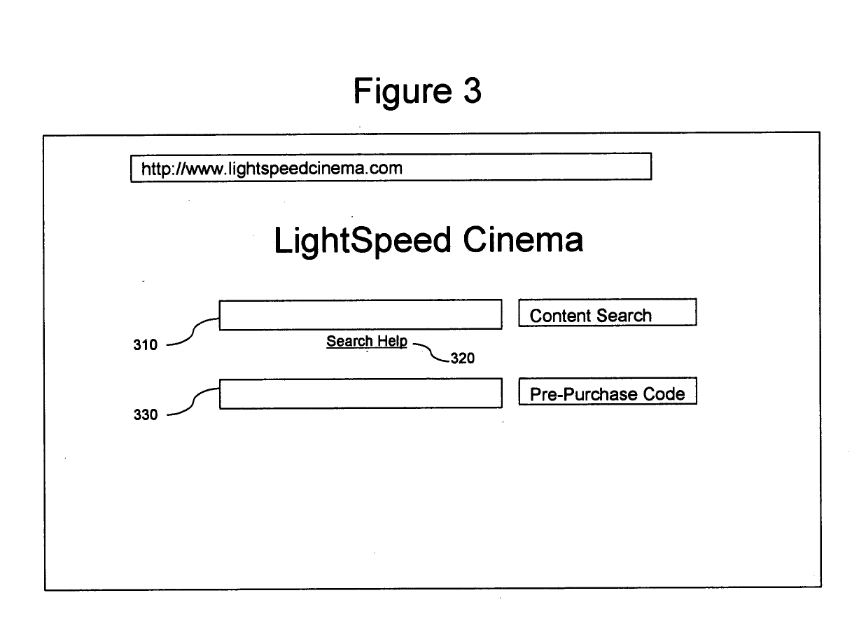

FIG. 3 shows a home page for a video distribution system in some embodiments of the invention. In some embodiments, the home page is rendered on a video display of mobile electronic device 104 after a user plugs into one of wired ports 107, opens a standard Web browser on mobile electronic device 104 and enters a URL uniquely assigned to the system (e.g. www.lightspeedcinema.com). In other embodiments, the home page is rendered upon plugging mobile electronic device 104 into one of wired ports 107 and executing on mobile electronic device 104 client software specially adapted for use with the system. In still other embodiments, the home page is displayed after the user has plugged into one of wired ports 107 and inputs payment card information that has been verified by the system. Payment card information may be input, for example, by swiping a payment card through one of payment card scanners 106.

The home page is designed, generally speaking, to maximize user friendliness and minimize distractions in consideration of the short time window available to “on the go” travelers. In some embodiments, the home page includes a search query box 310 for inputting keywords adapted to locate desired video content and an associated start search button that is depressed to initiate a search for the video content. The home page further includes a help link 320 to an instruction page that when activated links to information on how to use the search feature. The home page further includes a prepayment code box 330 for inputting a prepayment code. In this regard, to minimize the time users are connected to wired ports 107, users may prepay for video content before plugging in to wired ports 107 and receive a prepayment code that the system stores in association with prepaid video content. For example, a user may search, select and pay for video content using a home Internet connection or at travel departure terminal 108 using a wireless Internet connection before connecting to one of wired ports 107. Prepayment may be made through input on mobile electronic device 104 of payment card information that is verified by authorization server 240, An association between the prepaid video content and a prepayment code may then be stored on authorization server 240. Subsequently, upon connecting to one of wired ports 107 and reaching the home page, the user may input the prepayment code in prepayment code box 330 and, upon verification of the prepayment code by the authorization server 240, download the prepaid video content without additional searching.

In other embodiments, preselection of video content may be made before plugging in to wired ports 107 without prepayment. In these embodiments, users preselect video content and enter payment card information that they will use to pay for the video content when later connecting to one of wired ports 107. The system stores an association between the payment card information and the preselected video content but does not charge the user. The association between the preselected video content and payment card information may be stored on authorization server 240. Subsequently, upon connecting to one of wired ports 107, the user swipes through an associated one of payment card scanners 106 the payment card having the earlier entered payment card information and, upon verification of the payment card information by authorization server 240, begins downloading the preselected video content without further searching. The user may thereafter be charged for the video content based on the payment card information in the same manner as users who declined to preselect video content.

It will be appreciated that the video content preselection approaches described herein minimize connection times to wired ports 107 and enhance user privacy in that the user's search terms, search results and video content selections are not required to be rendered on the display of device 104 while the user is connected to one of wired ports 107.

In an exemplary operation of the video distribution system, a user plugs in mobile electronic device 104, such as a portable computer or a network-capable handheld device having a video display, to one of wired ports 107 on a short-term basis for downloading to mobile electronic device 104 one or more video files stored in video distribution facility 100 for playback while in transit and/or upon arrival at a travel destination. The system is designed such that connection times fit within the short time window available to “on the go” travelers. Generally speaking, the processing speed of access units 102 and the capacity of data links 101, 103 meet or exceed the hard disk processing rate on mobile electronic device 104 so as not to create a bottleneck to download of video content.

In some embodiments, downloaded video content is charged to an account associated with payment cards, which may be prepaid cards, credit cards or debit cards, that are swiped through payment card scanners 106 and verified by authorization server 240. In other embodiments, downloaded video content may additionally or alternatively be charged to a subscriber account authorized through verification by authorization server 240 of subscriber credentials and/or a prepayment code entered on a mobile electronic device, such as device 104. Subscriber credentials may include passwords, digital certificates, or personal identification (PIN) numbers, for example. Subscriber authorization may be performed in accordance with IEEE Std. 802.1X wherein mobile electronic devices 104 perform the supplicant role, access units 102 perform the authenticator role and the authorization server 240 performs the authentication server role.

In some embodiments, video content search and download sessions are conducted using TCP/IP-based flows. In these embodiments, the system may include a dynamic host configuration protocol (DHCP) server for allocating a dynamic IP address to mobile electronic device 104 for use in a video content search and download session.

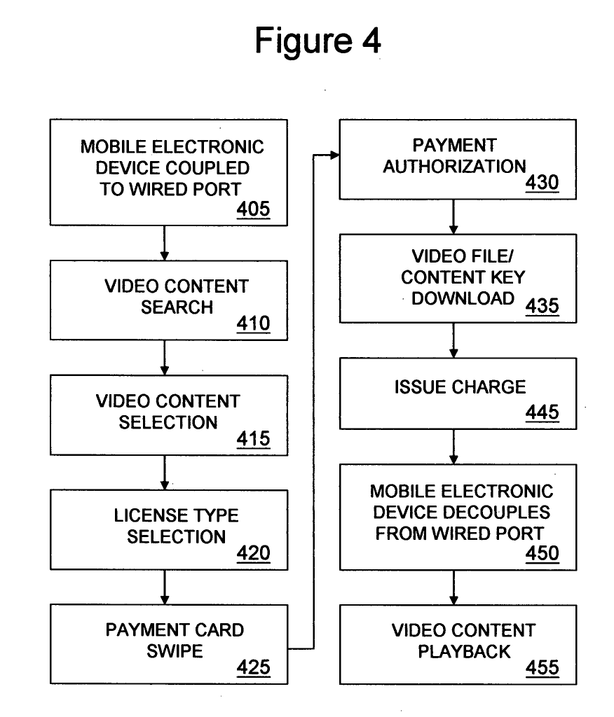

FIG. 4 shows a method for distributing video content without content preselection in some embodiments of the invention. Mobile electronic device 104 is communicatively coupled with one of wired ports 107 (405). In some embodiments, the user additionally opens a standard Web browser on mobile electronic device 104 and enters the URL for the system home page. Load balancer 210 receives a request for the home page and assigns the search and download session to a video server within video server array 220. The assigned video server processes the home page request and the home page is rendered on a video display of mobile electronic device 104.

The user then searches for desired video content (410). In some embodiments, mobile electronic device 104 enters a search term in a search query box on the home page and a search query on the search term is transmitted to the assigned video server. The video server consults local content index 225 and returns search results which are rendered on the video display of mobile electronic device 104. The search results identify video content stored in local video storage unit 230 that are relevant to the search term.

The user then selects video content from the search results (415). In some embodiments, the user selects video content by clicking on a search result identifying the video content rendered on the video display of mobile electronic device 104 and the selection is transmitted to the assigned video server, which consults content index 225 and returns license types available for the selected video content and associated prices that are rendered on the video display of mobile electronic device 104.

The user then selects a desired license type (420). In some embodiments, the user is presented with radio buttons for various license types available for the video content and associated prices. For example, a multi-tiered charge structure may be implemented wherein the user selects an access level and is charged accordingly. A user may pay a minimum fee for a single viewing or short-time license, a medium fee for multiple viewings or a medium-time license and a maximum fee for unlimited viewings or an unlimited time license. Access levels may be enforced through integration of digital rights management (DRM) restrictions with downloaded video content. The user selects a radio button and the selection is transmitted to the assigned video server, which returns a message requesting the user to swipe a payment card.

The user then swipes a payment card (425). In some embodiments, the user swipes a prepaid, credit or debit card through one of payment card scanners 106. Payment card information is read from the swiped payment card and transmitted to the assigned video server, which relays the payment card information and the price information obtained from the license type input to authorization server 240 for verification. Authorization server 240 then verifies that the account associated with the payment card information is authorized for a transaction in the amount of the price information (430) and notifies the assigned video server of successful authorization.

The video file and content key are then downloaded to mobile electronic device 104 (435). In some embodiments, the assigned video server requests a content key from license server 250 that includes DRM restrictions associated with the selected license type. The content key is adapted for use by mobile electronic device 104 to decrypt the downloaded video file, which is stored on local video storage unit 230 and downloaded therefrom in encrypted form. The license server 250 generates the content key and transmits it to mobile electronic device 104 using a secure communications protocol such as the Secure Sockets Layer (SSL) protocol. The encrypted video file is then downloaded to mobile electronic device 104 via fiber optic link 101.

A charge is then issued to the account associated with the payment card information (440). In some embodiments, the assigned video server notifies authorization server 240 of successful download of the video file and content key and authorization server 240 issues a charge to the account associated with the payment card information. It will be appreciated that postponing issuance of a charge until after successful download of the video file and content key allows the traveler to abort the download without being charged if, for example, his or her flight is leaving.

Mobile electronic device 104 is then decoupled from the one of wired ports 107 (445) and the video content is played back (450) at the user's convenience, for example, while in-transit or at a travel destination.

It will be appreciated that in the method of FIG. 4, a user is not required to identify a payment source before searching for video content. This has an advantage in that requiring payment information before desired video content has been identified for purchase by a user provides a disincentive to use the system. On the other hand, requiring a user to identify a payment source before being searching for video content can reduce frivolous use of system resources. Accordingly, in some embodiments, identification of a payment source may be required before a user is allowed to search for video content.

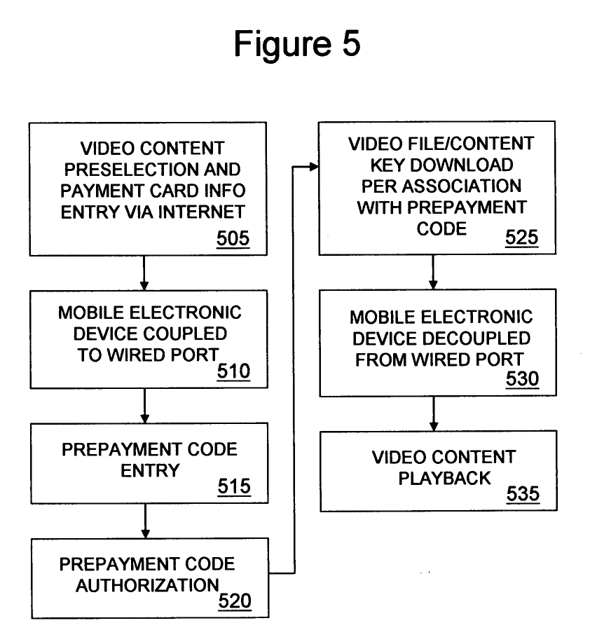

FIG. 5 shows a method for distributing video content with content preselection in some embodiments of the invention. The user preselects video content and enters payment card information over the Internet via a mobile or non-mobile electronic device (505). In some embodiments, the user connects to preselection server 270 over a home, work, or in-terminal Internet connection using a standard Web browser. The user then searches for desired video content. Preselection server 270 consults master content index 280 to determine which requested video content is available at the departure terminal from which the user indicates the user will later depart and returns search results to the user. The user then preselects video content from the search results and a desired license type and inputs payment card information, such as a credit card number, in the standard Web browser. Preselection server 270 relays the payment card information and price information associated with the desired license type to authorization server 240. Authorization server 240 charges the account associated with the payment card information in the amount of the price information and issues a prepayment code to preselection server 270. Alternatively, authorization server 240 may provide a charge notification to preselection server 270 and preselection server may generate the prepayment code. In either event, preselection server 270 transmits the prepayment code to the user and stores an association between the prepayment code and the preselected video content and license type. In some embodiments, the prepayment code is a multi-character alphanumeric code.

Mobile electronic device 104 is subsequently communicatively coupled with one of wired ports 107 (510) and the user enters the prepayment code (515). The video server to which the session has been assigned consults preselection server 270 to verify the prepayment code (520) and identify preselected video content and a license type associated with the prepayment code.

The preselected video file and content key are then downloaded to mobile electronic device 104 (525). In some embodiments, the assigned video server requests a content key from license server 250 that includes DRM restrictions associated with the preselected license type. The content key is adapted for use by mobile electronic device 104 to decrypt the downloaded video file, which is stored on local video storage unit 230 and downloaded therefrom in encrypted form. The license server 250 generates the content key and transmits it to mobile electronic device 104 using a secure communication protocol such as Secure Sockets Layer (SSL). The encrypted video file is then downloaded to mobile electronic device 104 via fiber optic link 101.

Mobile electronic device 104 is then decoupled from the one of wired ports 107 (530) and the video content is played back (535) at the user's convenience, for example, while in-transit or at a travel destination.

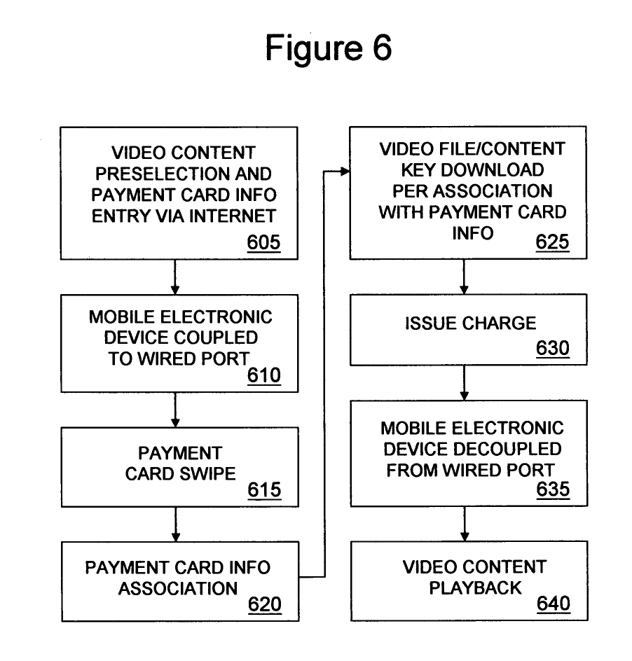

FIG. 6 shows a method for distributing video content with content preselection in other embodiments of the invention. The user preselects video content and enters payment card information over the Internet via a mobile or non-mobile electronic device (605). In some embodiments, the user connects to preselection server 270 over a home, work, or in-terminal Internet connection using a standard Web browser. The user then searches for desired video content. Preselection server 270 consults master content index 280 to determine which requested video content is available at the departure terminal from which the user indicates the user will later depart and returns search results to the user. The user then preselects video content from the search results and a desired license type and inputs payment card information, such as a credit card number, in the standard Web browser. Preselection server 270 stores an association between the payment card information and the preselected video content and license type.

Mobile electronic device 104 is subsequently communicatively coupled with one of wired ports 107 (610) and the user swipes the payment card having the earlier entered payment card information (615). In some embodiments, the user swipes a credit card through one of payment card scanners 106. Payment card information is read from the swiped payment card and transmitted to a video server to which the session has been assigned. The assigned video server consults preselection server 270 to identify preselected video content and a license type associated with the payment card information (620).

The preselected video file and content key are then downloaded to mobile electronic device 104 (625). In some embodiments, the assigned video server requests a content key from license server 250 that includes DRM restrictions associated with the preselected license type. The content key is adapted for use by mobile electronic device 104 to decrypt the downloaded video file, which is stored on local video storage unit 230 and downloaded therefrom in encrypted form. The license server 250 generates the content key and transmits it to mobile electronic device 104 using a secure communication protocol. The encrypted video file is then downloaded to mobile electronic device 104 via fiber optic link 101.

A charge is then issued to the account associated with the payment card information (630). In some embodiments, the assigned video server notifies authorization server 240 of successful download of the video file and content key and authorization server 240 issues a charge to the account associated with the payment card information.

Mobile electronic device 104 is then decoupled from the one of wired ports 107 (635) and the video content is played back (640) at the user's convenience.

The system elements described herein may be implemented in various combinations of hardware and software. It will be appreciated by those of ordinary skill in the art that the invention can be embodied in other specific forms without departing from the spirit or essential character hereof. The present description is therefore considered in all respects to be illustrative and not restrictive. The scope of the invention is indicated by the appended claims, and all changes that come within the meaning and range of equivalents thereof are intended to be embraced therein.

What is claimed is:

1. A video distribution system, comprising:
a video distribution facility within a travel departure zone, wherein the video distribution facility has video content files stored therein; and
one or more access units within one or more travel departure terminals of the travel departure zone, wherein each access unit is communicatively coupled with the video distribution facility via a respective wired connection and has one or more respective wired ports each adapted for short-term communicative coupling with a mobile electronic device to which one or more requested video content files stored in the video distribution facility is downloaded via the wired port for playback on the device at least in part after the device has been communicatively decoupled from the wired port.

2. The video distribution system of claim 1 further comprising a video management facility outside the travel departure zone and communicatively coupled with the video distribution facility via the public Internet, wherein video content files are uploaded from the video management facility to the video distribution facility via the public Internet for storage.

3. The video distribution system of claim 1, wherein the one or more travel departure terminals comprise a plurality of travel departure terminals.

4. The video distribution system of claim 1, wherein the travel departure zone comprises an airport and the one or more travel departure terminals are airport terminals.

5. The video distribution system of claim 1, wherein the wired port comprises an Ethernet port.

6. The video distribution system of claim 1, wherein the wired port comprises a Universal Serial Bus (USB) port.

7. The video distribution system of claim 1, wherein the mobile electronic device comprises a portable computer.

8. The video distribution system of claim 1, wherein the mobile electronic device comprises a network-capable handheld device having a video display.

9. The video distribution system of claim 1, wherein the one or more requested video content files comprise high definition content.

10. The video distribution system of claim 1, wherein the one or more requested video content files comprise standard definition content.

11. The video distribution system of claim 1, wherein the one or more requested video content files comprise one or more of a video game and a software application.

12. The video distribution system of claim 1, wherein the one or more downloaded video content files include one or more digital rights management (DRM) restrictions.

13. The video distribution system of claim 12, wherein the one or more DRM restrictions include one or more of a play count restriction and a play time restriction.

14. A travel departure zone, comprising:
a video storage unit;
a video server array communicatively coupled with the video storage unit;
a load balancer communicatively coupled with the video server array; and
one or more access units each communicatively coupled with the load balancer via a respective wired connection and each having one or more respective wired ports each adapted for communicative coupling with a mobile electronic device to which the load balancer assigns a video server within the video server array for conducting a session with the device in which one or more video content files is downloaded from the video storage unit to the device via the wired port for playback on the device at least in part after the device has been communicatively decoupled from the wired port.

15. The travel departure zone of claim 14, further comprising a content index communicatively coupled with the video server and wherein the session includes a keyword search in which the video server consults the content index and identifies the video content files as being stored on the video storage unit.

16. The travel departure zone of claim 14, wherein the travel departure zone comprises an airport.

17. The travel departure zone of claim 14, wherein the wired port comprises one of an Ethernet port and a USB port.

18. The travel departure zone of claim 14, wherein the mobile electronic device comprises one of a portable computer and a network-capable handheld device having a video display.

19. A method for distributing video content in a travel departure zone comprising the steps of:
uploading a video content file to a video distribution facility within the travel departure zone; then,
communicatively coupling a mobile electronic device to a wired port within a travel departure terminal of the travel departure zone;
requesting the uploaded video content file via the wired port;
downloading the requested video content file via the wired port;
communicatively decoupling the device from the wired port; and then,
commencing playback on the device of the downloaded video content file.
